(19) United States
(12) Patent Application Publication
(10) Pub. No.: US 2024/0015393 A1
(43) Pub. Date: Jan. 11, 2024

(54) VIDEO SHOOTING METHOD, DEVICE AND SYSTEM

(71) Applicant: SZ DJI TECHNOLOGY CO., LTD., Shenzhen (CN)

(72) Inventor: Shuai LIU, Shenzhen (CN)

(73) Assignee: SZ DJI TECHNOLOGY CO., LTD., Shenzhen (CN)

(21) Appl. No.: 18/372,861

(22) Filed: Sep. 26, 2023

Related U.S. Application Data
(63) Continuation of application No. PCT/CN2021/084449, filed on Mar. 31, 2021.

(51) Int. Cl. H04N 23/60; H04N 23/667; H04N 23/695

(52) U.S. Cl. CPC H04N 23/64; H04N 23/667; H04N 23/695

(57) ABSTRACT

A video shooting method device and system is provided. The method includes: determining a category of an object, and determining a target lens motion mode for shooting a video of the object based on the category of the object, so as to shoot the video of the object with the target lens motion mode. This method may reduce the requirements on the user's video shooting skills and facilitate video shooting.

### RELATED APPLICATIONS

This application is a continuation application of PCT application No. PCT/CN2021/084449, filed on Mar. 31, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of computer technologies, and in particular to a video shooting method, device and system.

### BACKGROUND

With the continuous development of the computer technologies, the application of support device used to support a shooting device becomes broad. The support device may be, for example, a handheld gimbal, or the like.

### SUMMARY

Embodiments of the present disclosure provides a video shooting method, device and system to solve the problems in the existing technology that users are required to conceive of motion shooting skills for an object, users' shooting skills are required to be high, and it is inconvenient for users to shoot.

In one aspect, the present disclosure provides a video shooting method, including: determining a category of an object; and determining, based on the category of the object, a target lens motion mode for shooting a video of the object, so as to shoot the video of the object with the target lens motion mode.

In another aspect, the present disclosure provides a video shooting assistance device, including: at least one memory storing a set of instructions for assisting video shooting; and at least one processor in communication with the at least one memory, where during operation, the at least one processor executes the set of instructions to: determine a category of an object, and determine, based on the category of the object, a target lens motion mode for shooting a video of the object, so as to shoot the video of the object with the target lens motion mode.

In yet another aspect, the present disclosure provides a video shooting system, including: a video shooting assistance device; and a carrying mechanism for carrying a video shooting device, where the video shooting assistance device is arranged on the carrying mechanism, and the video shooting assistance device includes: at least one memory storing a set of instructions for assisting video shooting, and at least one processor in communication with the at least one memory, where during operation, the at least one processor executes the set of instructions to: determine a category of an object, and determine, based on the category of the object, a target lens motion mode for shooting a video of the object, so as to shoot the video of the object with the target lens motion mode.

Embodiments of the present disclosure provide a video shooting method, device and system. By determining the category of a shooting object and determining a target lens motion mode for shooting the shooting object according to the category of the shooting object, a video of the shooting object is shot with the target lens motion mode. It realizes the automatic determination of the target lens motion mode for shooting a video of the shooting object according to the category of the shooting object, so that a user does not need to conceive of the motion shooting techniques for the shooting object. It can reduce the requirements on the user's shooting skills and facilitate the user's video shooting.

### BRIEF DESCRIPTION OF THE DRAWINGS

In order to more clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is a schematic diagram of exemplary components of a video shooting system according to some exemplary embodiments of the present disclosure;

FIG. 2 is a flow chart of a video shooting method according to some exemplary embodiments of the present disclosure;

FIG. 3 is a flow chart of a video shooting method according to some exemplary embodiments of the present disclosure;

FIG. 4 is a flow chart of a video shooting method according to some exemplary embodiments of the present disclosure; and

FIG. 5 is a schematic diagram of the structure of a video shooting device according to some exemplary embodiments of the present disclosure.

### DETAILED DESCRIPTION

The technical solutions in some exemplary embodiments of the present disclosure will be described below in conjunction with the drawings for clear understanding of the purpose, technical solutions and advantages of the embodiments of the present disclosure. Apparently, the described embodiments are some exemplary embodiments of the present disclosure, but not all of them. Based on the examples disclosed herein, all other embodiments obtained by a person of ordinary skill in the art without creative efforts should fall within the scope of protection of the present disclosure.

Usually, users may use a shooting device mounted on a support device to take video shots of objects using a motion lens. Specifically, a user first needs to conceive of the motion shooting techniques needed for an object, then control the motion of the support device according to the motion shooting techniques conceived of to drive the lens of the shooting device to move, and then control the shooting device to shoot the object during the motion.

However, the above-mentioned method has a problem that it requires a high level of shooting skills of the user and is inconvenient for the user to take pictures or videos.

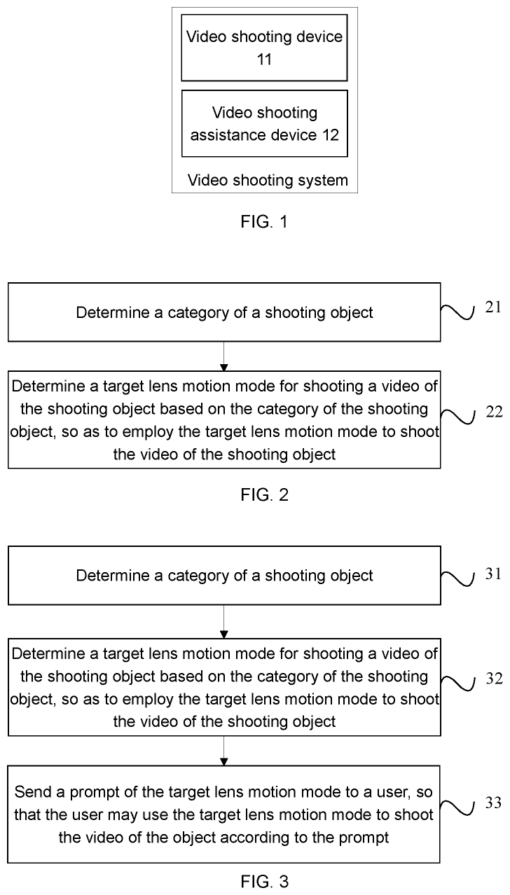

A video shooting method provided in some exemplary embodiments of the present disclosure may be applied to the video shooting system shown in FIG. 1. As shown in FIG. 1, the video shooting system may include a shooting device (video shooting device) 11 and a video shooting device (video shooting assistance device) 12. The video shooting device 11 is used for video shooting of a shooting object (target object). The video shooting device 11 may be, for example, a video camera, a webcam, a camera, a mobile phone, etc. The video shooting assistance device 12 may execute a video shooting method provided by some exemplary embodiments of the present disclosure. In order to determine the lens motion mode that needs to be used when the video shooting device 11 performs video shooting on the shooting object.

Specifically, the video shooting assistance device 12 may determine the category of the shooting object, and determine a target lens motion mode for shooting the object according to the category of the object. The target lens motion mode is configured to capture a video of the shooting object. It should be noted that the determination of the target lens motion mode herein is based on the category of the shooting object. It can be based only on the category of the shooting object without caring about the relationship between the object and the surrounding scenery. That is, the determination of the target lens motion mode may be independent of the shooting scene where the shooting object is located.

In some exemplary embodiments, a user may manually adopt the target lens motion mode to capture a video of the shooting object. That is, the user may perform the video shooting of the shooting object with the target lens motion mode by manually controlling the video shooting device 11. In this case, after determining the target lens motion mode, the video shooting assistance device 12 may further prompt the user about the target lens motion mode.

In some exemplary embodiments, the video shooting assistance device 12 may automatically adopt the target lens motion mode to perform video shooting of the shooting object. That is, the video shooting assistance device 12 may perform the video shooting of the shooting object with the target lens motion mode by automatically controlling the video shooting device 11 and a carrying mechanism equipped with the video shooting device 11. In this case, the carrying mechanism may be used to drive the video shooting device 11 to move and/or rotate. In this case, after determining the target lens motion mode, the video shooting assistance device 12 may further generate a control instruction for controlling the carrying mechanism and the video shooting device 11 based on lens motion parameters of the target lens motion mode.

Exemplarily, the carrying mechanism may include a motion mechanism and/or a rotating mechanism. The motion mechanism may be used to drive the video shooting device to move, and the rotating mechanism may be used to drive the shooting device to rotate. It should be noted that the specific form of a combination of the carrying mechanism and the video shooting device may be flexibly selected and implemented according to needs, and is not limited herein.

In some exemplary embodiments, the carrying mechanism may include a rotating mechanism, and the video shooting device 11 may be installed on the rotating mechanism. For example, the rotation mechanism may include a gimbal or a mechanical arm. When the rotating mechanism includes a gimbal, the gimbal may be fixedly connected to the video shooting device 11, such as in the form of a gimbal camera. Alternatively, the gimbal may be detachably connected to the video shooting device 11, such as a combination of a handheld gimbal and a mobile phone.

In some exemplary embodiments, the carrying mechanism may include a motion mechanism, and the video shooting device 11 may be installed on the motion mechanism. For example, the motion mechanism may include a slide rail. Exemplarily, the motion mechanism includes the body of a vehicle, and the vehicle includes the body of an unmanned aerial vehicle (UAV) or an unmanned vehicle (UV). That is to say, the body is equipped with a power system that may drive the body to move.

In some exemplary embodiments, the carrying mechanism may include a rotating mechanism and a motion mechanism. The video shooting device 11 may be installed on the rotating mechanism, and the rotating mechanism may be installed on the motion mechanism. For example, the rotating mechanism may include a gimbal or a mechanical arm, and the motion mechanism may include a slide rail. For example, the rotating mechanism may include a gimbal, and the motion mechanism may include the body of a UAV or UV. It can be understood that in this case, the video shooting device 11 may be installed on the motion mechanism via the rotating mechanism.

When the carrying mechanism includes the rotating mechanism and the motion mechanism, there may be a linkage control between the rotating mechanism and the motion mechanism. The linkage control herein may be understood as using a certain control method so that the rotation of the video shooting device driven by the rotating mechanism and the motion of the video shooting device driven by the motion mechanism may start and/or end at the same time, and/or reach a certain set of corresponding rotational and motion positions simultaneously.

It should be noted that the video shooting assistance device 12 may directly control the carrying mechanism and/or the video shooting device 11; alternatively, the video shooting assistance device 12 may indirectly control the carrying mechanism and/or the video shooting device 11 by sending control instructions to a control terminal for controlling the carrying mechanism and/or the video shooting device 11.

It should also be noted that in FIG. 1, the video shooting device 11 and the video shooting assistance device 12 may be located in/at the same device, or they may be located in/at different devices. Some exemplary embodiments of the present disclosure will be described in detail below with reference to the accompanying drawings. The following exemplary embodiments and features in these embodiments may be combined with each other without conflict.

FIG. 2 is a flow chart of a video shooting method according to some exemplary embodiments of the present disclosure. In some exemplary embodiments, the execution subject herein may be the video shooting assistance device 12 shown in FIG. 1. Specifically, it may be a processor of the video shooting assistance device 12. As shown in FIG. 2, the method of the present disclosure may include:

Step 21: Determine a category of a shooting object.

In this step, the specific method of determining the category of the shooting/target object may be flexibly implemented according to needs. In some exemplary embodiments, the category of the object may be determined by way of user input. Exemplarily, step 21 may specifically include: according to an object setting instruction input by a user, determine the category of the shooting/target object.

In some exemplary embodiments, the object setting instruction may be used to set the object name of the shooting object. The category of the shooting object then may be determined based on the name of the shooting object. The object setting instruction may be, for example, a text box input instruction for inputting the name of a certain object. Of course, in some exemplary embodiments, the object setting instructions may also be other types of instructions, which are not limited herein.

In some exemplary embodiments, the object setting instruction may be used to set the category of the shooting object. The category set by the object setting instruction may be used as the category of the shooting object. The object setting instruction may be, for example, a click instruction for a certain preset category among multiple preset categories. Of course, in some exemplary embodiments, the object setting instructions may also be other types of instructions, which are not limited herein.

In some exemplary embodiments, the category of the shooting object may be determined by image identification. Exemplarily, step 21 may specifically include: obtain an image including the shooting object, and identify the image to determine the category of the shooting object.

For example, an image including the shooting object may be obtained from a video shooting device 11. In another example, the image may include an image including the shooting object sent by another device/devices communicatively connected to the video shooting device 11. Of course, in some exemplary embodiments, the image including the shooting object may also be obtained through other methods and is not limited in herein.

For example, the image including the shooting object may be input to a deep learning model, so that the image can be identified by the deep learning model to determine the category of the shooting object. Of course, in some exemplary embodiments, the image may also be identified in other ways, which is not limited in herein.

It should be noted that in some exemplary embodiments of the present disclosure, the classification granularity of object categories may be flexibly implemented according to specific lens operation requirements. For example, the category of object may include animals. In this case, all types of animals can be videoed using the same lens motion mode. In another example, the category of animals may further include cats, dogs, birds, etc. In this case, cats, dogs and birds may use different lens motion modes for video recording.

It can be understood that the lens motion modes of objects of different categories may be the same. For example, suppose the categories of plants, animals, and people are further divided. The recommended lens motion modes for different plants may be the same. The recommended lens motion modes for different animals may be the same. The recommended lens motion modes for different characters may also be the same. On the other hand, there may be multiple lens motion modes for objects of the same category.

Step 22: Determine a target lens motion mode for shooting a video of the shooting object based on the category of the shooting object, so as to employ the target lens motion mode to shoot the video of the shooting object.

In this step, the target lens motion mode may refer to a recommended lens motion mode for video shooting of the shooting object. For the shooting object, the target lens motion mode may be used to shoot the video of the object, and a video with better shooting effect may be obtained. The number of target lens motion modes may be one or more.

The specific method of determining the target lens motion mode for shooting the object according to the category of the object to may be flexibly implemented according to needs. For example, a query request indicating the category of the object may be sent to a server, and a query response indicating the target lens motion mode may be returned by the server in response.

According to the a video shooting method described above, by determining the category of a shooting object and determining a target lens motion mode for shooting the shooting object according to the category of the shooting object, a video of the shooting object is shot with the target lens motion mode. It realizes the automatic determination of the target lens motion mode for shooting a video of the shooting object according to the category of the shooting object, so that a user does not need to conceive of the motion shooting techniques for the shooting object. It can reduce the requirements on the user's shooting skills and facilitate the user's video shooting.

FIG. 3 is a flow chart of a video shooting method according to some exemplary embodiments of the present disclosure. On the basis of the exemplary embodiments described in FIG. 1, an exemplary implementation method after determining the target lens motion mode will be further described below. As shown in FIG. 3, the method may include:

Step 31: Determine a category of a shooting object.

It should be noted that step 31 is similar to step 21 and will not be described again herein.

Step 32: Determine a target lens motion mode for shooting a video of the shooting object according to the category of the shooting object, so as to employ the target lens motion mode to shoot the video of the shooting object.

In this step, for example, the target lens motion mode for shooting a video of the object may be determined according to the category of the object and the correspondence between object categories and different lens motion modes. It can be understood that the lens motion mode corresponding to a certain object category in the correspondence relationship may refer to the lens motion mode recommended for video shooting of objects in this category, which may result in better video effects. For example, assuming that the category of the is fruit, and the corresponding relationship is as shown in Table 1 below, then it may be determined that the target lens motion mode is lens motion mode c.

TABLE 1

| Category | Lens Motion Mode |
|---|---|
| toy | lens motion mode a |
| tewelry | lens motion mode b |
| fruit | lens motion mode c |
| . . . | . . . |

The correspondence relationship may be flexibly implemented according to needs. For example, the correspondence relationship may include a preset correspondence relationship between an object category and a lens motion mode, and/or a correspondence relationship between an object category generated based on the obtained video and a lens motion mode. For example, the lens motion parameters corresponding to a certain object or certain objects may be obtained from a person with photography experience, so that the correspondence relationship between the object category and the lens motion mode may be set in advance. In another example, parameter analysis may be performed based on the obtained video. By analyzing the category of the object captured in the video and the lens motion parameters used in the video shooting, the correspondence relationship between the object category and the lens motion mode may be generated. The lens motion parameters include at least one of a lens motion mode, a shooting control parameter, or an image transmission processing parameter. Of course, in some exemplary embodiments, the correspondence between the object category and the lens motion mode may also be obtained by other methods, which is not limited herein.

In some exemplary embodiments, when there is a plurality of target lens motion modes, a user may select one from the plurality of target lens motion modes. For example, after step 32, the method may also include: determine a target lens motion mode selected by a user among a plurality of target lens motion modes, so as to use the target lens motion mode selected by the user to shoot the video of the object. For example, the target lens motion mode selected by the user among the plurality of target lens motion modes may be determined by obtaining the user's selection operation for the identification of a certain target lens motion mode among the plurality of target modes. Of course, in some exemplary embodiments, the target lens motion mode selected by the user may also be determined in other ways, which is not limited herein. In some cases, the user may be prompted for the target lens motion mode selected by the user in step 33, so that the user may use the selected target lens motion mode to perform video shooting of the object according to the prompt.

In some exemplary embodiments, when there are multiple target lens motion modes, step 32 may also include: obtain a user's fusion operation for the multiple target lens motion modes; fuse at least two target lens motion modes among the multiple target lens motion modes according to the fusion operation to obtain a new target lens motion mode, and the new target lens motion mode may be used to shoot the video of the object to. Taking the fusion operation for fusing two target lens motion modes as an example, the fusion operation includes, but is not limited to, the following methods: splice the two target lens motion modes head to tail; insert one of the two target lens motion modes into the other target lens motion mode; delete a part of one of the two target lens motion modes, and splice the remaining part of the target lens motion mode with the other target lens motion mode head to tail; delete a part of one target lens motion mode of the two target lens motion modes, and insert the remaining part of the target lens motion mode into the other target lens motion mode, or insert the other target lens motion mode into the remaining part of the target lens motion mode; delete a part from each of the two target lens motion modes, and splice the remaining parts of the two target lens motion modes head to tail; delete a part from each of the two target lens motion modes and insert the remaining part of one target lens motion mode into the remaining part of the other target lens motion mode. In this case, in step 33, the user may be prompted with the new target lens motion mode, so that the user may use the new target lens motion mode to shoot the video of the object according to the prompt.

Step 33: Send a prompt of the target lens motion mode to a user, so that the user may use the target lens motion mode to shoot the video of the object according to the prompt.

In this step, the specific method of prompting the user about the target lens motion mode may be flexibly implemented according to needs. In some exemplary embodiments, step 33 may specifically include: play a demonstration video of the target lens motion mode, so that the user may use the target lens motion mode to shoot the video of the object after watching the demonstration video of the target lens motion mode.

In the absence of a pause instruction or a stop instruction, the demonstration video of the target lens motion mode may be played until reach the end of the demonstration video. Thus, a user may, after watching the demonstration video of the target lens motion mode, use the target lens motion mode demonstrated in the demonstration video to shoot the video of the object. When the target lens motion mode is easy to achieve, or the user's shooting skills are high, this may improve the efficiency of prompting the user with the target lens motion mode, and is conducive to improving the user experience.

In some exemplary embodiments, on the basis of playing the demonstration video of the target lens motion mode, lens motion mode prompt information about the target lens motion mode may also be output to the user. This allows the user to more clearly understand the target lens motion mode, which is beneficial to improving the user experience. The mode prompt information may be flexibly implemented according to needs. Exemplarily, the lens motion mode prompt information may include at least one of the following: prompt information about a lens angle, prompt information about a lens orientation, prompt information about a lens motion mode, or prompt information about a lens motion speed.

The lens angle refers to a horizontal angle between the lens and the shooting object. The lens angle may be divided into a head-up shot lens angle, a downward-looking shot lens angle, and an upward-looking shot lens angle. The lens orientation refers to the orientation of the lens with respect to the shooting object. The lens orientation may be divided into, for example, a front shot, a side shot, a rear shot, and a top shot. The lens motion mode refers to the motion of the lens. The lens motion mode may be divided into, for example, push, pull, pan, translocate, rise, fall, follow and surround. The lens motion speed refers to the speed of lens motion. The lens motion speed may be divided into, for example, fast, medium and slow. Of course, in some exemplary embodiments, the lens angle, lens orientation, lens motion mode and lens motion speed may also be of other types, which are not limited herein.

For example, the lens motion mode prompt information may be “head-up front shot push fast,” in which “head-up” may be the prompt information about the lens angle; “front shot” may be the prompt information about the lens orientation; “push” may be prompt information about the lens motion; and “fast speed” may be the prompt information about the lens motion speed. In another example, the lens motion mode prompt information may be “head-up front shot surround medium,” in which “head-up” may be the prompt information about the lens angle; “front shot” may be the prompt information about the lens orientation; “surround” may be prompt information about the lens motion; and “medium” may be the prompt information about the lens motion speed.

In some exemplary embodiments, step 33 may specifically include: play the demonstration video of the target lens motion mode in segments, so that the user may use the target lens motion mode to take video of the object during a process of watching the demonstration video of the target lens motion mode. In this case, the demonstration video of the target lens motion mode is played in segments. That is, after a segment has been played, it automatically pauses and waits for the user to shoot a video based on the part of the target lens motion mode that has been demonstrated; then after the video shooting is paused, the next segment is played, so that the user may learn and use the target lens motion mode in segments. When the target lens motion mode is difficult to achieve, or the user's video shooting skills are low, it may facilitate the user to learn the target lens motion mode, which is conducive to improving the user experience.

It should be noted that during the segmented playing process, the obtained video of the object is also shot in segments. Thus, after the shooting is completed, the multiple video segments obtained may be spliced to obtain a full video of the object. Moreover, since the shooting of the object is carried out in segments, if the shooting direction and shooting position at the beginning of a segment of shooting are inconsistent with those at the end of a preceding segment of shooting, when performing the final video following the multi-segment splicing, there may be a problem of abrupt video images. In order to solve this problem, when it is detected that the shooting direction and/or shooting position at the beginning of a new segment of shooting is inconsistent with those at the end of the preceding segment of shooting, the user may be prompted to make corresponding adjustments so that the shooting direction and shooting position at the beginning of this period of shooting are consistent with the end of the preceding period of shooting.

Similarly, on the basis of playing the demonstration video of the target lens motion mode in segments, the lens motion mode prompt information about the target lens motion mode may also be output to the user.

In some exemplary embodiments, step 33 may specifically include: during the video shooting process of the object, output operation prompt information for achieving the target lens motion mode to the user. In this case, the operation prompt information refers to the prompt information for operating a carrying mechanism that may be used to drive the video shooting device to move and/or rotate. With the prompt of the operation prompt information, the user may perform according to the operation prompt information, which may realize shooting of the object with the target lens motion mode. For example, before the next shooting action of the object starts, output prompt information for frame selection, click selection or motion corresponding to the shooting action on an interface. Of course, in some embodiments, the operation prompt information may also be output in other ways, which is not limited herein.

In some exemplary embodiments, one of the above three modes for prompting the user with the target lens motion mode may be selected; alternatively, one of three modes for prompting the user with the target lens motion mode may be selected based on a user input.

According to the a video shooting method described above, by determining the category of a shooting object and determining a target lens motion mode for shooting the shooting object according to the category of the shooting object, prompts the user with the target lens motion mode determined so that the user may employ the target lens motion mode to shoot the video of the object according to the prompt. It enables the user to shoot the object according to the prompted target lens motion mode. In this way, a user does not need to conceive of the motion shooting techniques for the shooting object. It can reduce the requirements on the user's shooting skills and facilitate the user's video shooting.

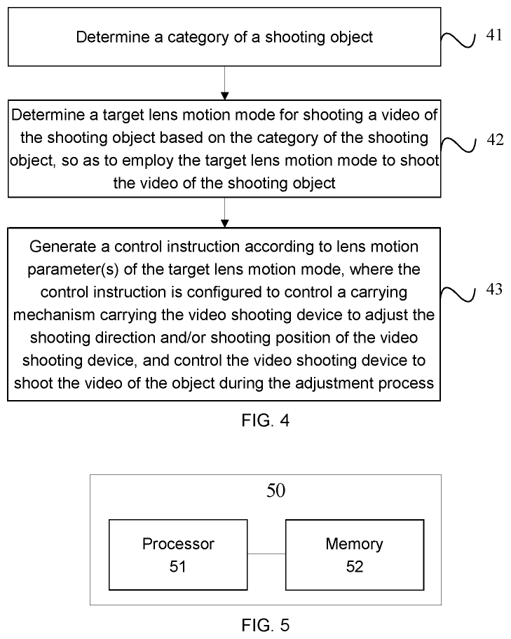

FIG. 4 is a flow chart of a video shooting method according to some exemplary embodiments of the present disclosure. On the basis of the exemplary embodiments described in FIG. 1, an exemplary implementation method after determining the target lens motion mode will be further described below. As shown in FIG. 4, the method may include:

Step 41: Determine a category of a shooting object.

It should be noted that step 41 is similar to step 21 and will not be described again herein.

Step 42: Determine a target lens motion mode for shooting a video of the shooting object according to the category of the shooting object, so as to employ the target lens motion mode to shoot the video of the shooting object.

It should be noted that step 42 is similar to step 22 and step 32, and will not be described again herein.

Similarly, when the number of target lens motion modes is multiple, the multiple target lens motion modes may be selected by the user. For example, after step 42, the method may also include: determine the target lens motion mode selected by the user among the plurality of target lens motion modes, so as to use the target lens motion mode selected by the user to shoot the video of the object. In this case, in step 43, the control instruction may be generated according to the lens motion parameter(s) of the target lens motion mode selected by the user.

In some exemplary embodiments, when there are multiple target lens motion modes, step 42 may also include: obtain the user's fusion operation for the multiple target lens motion modes; and fuse at least two target lens motion modes among the multiple target lens motion modes according to the fusion operation to obtain a new target lens motion mode. The new target lens motion mode is used to shoot the video of the object. In this case, in step 43, a control instruction may be generated according to the lens motion parameter(s) of the new target lens motion mode.

Step 43: Generate a control instruction according to lens motion parameter(s) of the target lens motion mode, where the control instruction is configured to control a carrying mechanism carrying the video shooting device to adjust the shooting direction and/or shooting position of the video shooting device, and control the video shooting device to shoot the video of the object during the adjustment process.

In this step, the lens motion parameters refer to parameters that enable video shooting of the object with the target lens motion mode. For example, the lens motion parameters may include: lens motion direction parameters, lens motion speed parameters, and lens motion duration parameters. It should be noted that the lens motion parameters of the target lens motion mode may include one or more sets. A set of lens motion parameters of the target lens motion mode may correspond to a lens motion mode in the target lens motion mode. The lens motion direction parameters in a set of lens motion parameters refer to the direction parameter used to achieve a lens motion mode in the target lens motion mode. The lens motion speed parameters refer to the motion speed parameters in the lens motion mode. The lens motion duration parameters refer to the motion duration parameters in the lens motion mode.

It should be noted that in actual applications, some lens motion modes may involve the adjustment of the shooting position of the video shooting device, without affecting the shooting direction of the video shooting device. These lens motion modes may be, for example, “push,” “pull,” “translocate,” “rise” and “fall,” etc. In practical applications, some lens motion modes may involve the adjustment of the shooting direction of the video shooting device without affecting the shooting position of the video shooting device. These lens motion modes may be, for example, “pan,” and the like. In practical applications, some lens motion modes may involve adjusting both the shooting direction and shooting position of the shooting device at the same time. These lens motion modes may be, for example, “follow” and “surround.”

Assuming that a target lens motion mode includes a set of lens motion parameters, the lens motion direction parameters in this set of lens motion parameters is used to realize the “push” mode of lens motion. The lens motion speed parameter is high speed, and the lens motion duration parameter is 5 seconds. Then the following control may be achieved by control instructions: at a certain moment, the carrying mechanism is controlled to start driving the video shooting device to move close to a shooting object along an optical axis of the video shooting device at a “high speed,” and the video shooting device is controlled to start video shooting at the same time; then, when the motion duration reaches 5 seconds, the carrying mechanism is controlled to stop motion, and at the same time, the video shooting device is controlled to stop video shooting.

In some exemplary embodiments, when the carrying mechanism is directly controlled by the video shooting assistance device 12, after step 43, the method may also include: perform corresponding control on the carrying mechanism according to a control instruction.

In some exemplary embodiments, when the video shooting device is directly controlled by the video shooting assistance device 12, after step 43, the method may also include: perform corresponding control on the video shooting device according to a control instruction.

In some exemplary embodiments, after step 43, the method may also include: send the control instruction to a control terminal capable of controlling the carrying mechanism and/or the video shooting device, and the control terminal controls the carrying mechanism and/or the video shooting device accordingly according to the control instruction.

For example, in the case where one of the carrying mechanism and the video shooting device is directly controlled by the video shooting assistance device 12, and the other is not directly controlled by the video shooting assistance device 12, the control instruction may include a first control instruction for controlling the carrying mechanism and a second control instruction for controlling the video shooting device. After step 43, the method may also include: control the carrying mechanism according to the first control instruction, and send the second control instruction in the control instruction to a control terminal configured to control the video shooting device, the control terminal performs corresponding control on the video shooting device according to the second control instruction; alternatively, control the video shooting device according to the second control instruction, and send the first control instruction in the control instruction to a control terminal configured to control the carrying mechanism, and the control terminal controls the carrying mechanism according to the first control instruction.

For example, In the case where neither the carrying mechanism nor the video shooting device is directly controlled by the video shooting assistance device 12, after step 43, the method may also include: send the control instruction to a control terminal configured to control the carrying mechanism and the video shooting device, so that the control terminal controls the carrying mechanism and the video shooting device accordingly according to the control instruction. It should be noted that the control terminal used to control the carrying mechanism and the video shooting device may be the same control terminal, or may be different control terminals. When they are different control terminals, the control instruction may include a first control instruction for controlling the carrying mechanism and a second control instruction for controlling the video shooting device, and the first control instruction and the second control instruction may be sent to the corresponding control terminals.

According to the video shooting method provided by some exemplary embodiments of the present disclosure, the category of a shooting object may be determined and a target lens motion mode for shooting a video the object may be determined according to the category of the shooting object, a control instruction may be generated based on lens motion parameters of the target lens motion mode; the control instruction may be used to control a carrying mechanism carrying the video shooting device to adjust the shooting direction and/or shooting position of the video shooting device, and to control the video shooting device to shoot the video of the object during an adjustment process. It realizes the automatic determination of the target lens motion mode for video shooting the object, and automatically shoots the video based on the determined target lens motion mode. It does not require users to conceive of motion shooting techniques or perform actual shooting operations, which can save labor costs.

In some exemplary embodiments, based on the above description, the method may further include: in a process of video shooting of the shooting object, shooting control may be performed according to the shooting control parameters corresponding to the target lens motion mode, so as to obtain the shooting control effect corresponding to the target lens motion mode. Therefore, the shooting control method corresponding to the target lens motion mode may be used to control the video shooting process of the object to automatically obtain the video shooting effect corresponding to the target lens motion mode, simplify user operations, and help improve the user experience. In this case, the shooting control parameters may be flexibly selected according to needs. Exemplarily, the shooting control parameters may include one or more of the following: zoom parameters, focus parameters, tracking parameters or exposure parameters, where the tracking parameters refer to parameters used to track the target so that the target may be maintained at a certain position or a certain range in an image(s). The target or object in the present disclosure specifically refers to shooting object.

In some exemplary embodiments, based on the above description, the method may further include: use image processing parameters corresponding to the target lens motion mode to perform corresponding image processing on the video frames obtained by video shooting of the object, so as to obtain the image processing effect corresponding to the target lens motion mode. Therefore, the image processing parameters corresponding to the target lens motion mode may be used to process the video frames captured for the object, and the image processing effect corresponding to the target lens motion mode may be automatically obtained, simplifying user operations, and helping to improve user experience. In this case, the image processing parameters may be flexibly selected according to needs. Exemplarily, the image processing parameters may include one or more of the following: skin smoothing parameters, color adjustment parameters, brightness adjustment parameters, blur parameters, or filter parameters.

In some exemplary embodiments, based on the above description, prior to determining the category of the shooting object, the method may also include: enter an object shooting mode according to a mode setting instruction input by a user. The object shooting mode is a shooting mode used to determine the lens motion mode according to the category of the object. This allows users to flexibly choose whether to enable the function of determining the lens motion mode based on the category of the object according to actual needs, which is beneficial to improving the user experience. In this case, the mode setting instruction may be, for example, a selection instruction with the text “object shooting mode” displayed on a screen. Of course, in some exemplary embodiments, the mode setting instruction may also be other types of instructions, which is not limited herein.

FIG. 5 is a schematic diagram of the structure of a video shooting device according to some exemplary embodiments of the present disclosure. As shown in FIG. 5, a device 50 may include: at least one processor 51 and at least one memory 52.

The at least one memory 52 may be configured to store program code.

The at least one processor 51 may be configured to invoke the program code, and when the program code is executed, it may be used to perform the following operations:

Determine the category of a shooting object;

According to the type of the shooting object, determine a target lens motion mode for shooting a video of the shooting object, so that the target lens motion mode is used to shooting the video of the shooting object.

In some exemplary embodiments, when the processor is also used to generate a control instruction according to the lens motion parameters of the target lens motion mode, the device 50 may further include a transmitter (not shown) for sending the control instruction to a control terminal capable of controlling the carrying mechanism and/or the video shooting device, and the control terminal controls the carrying mechanism and/or the video shooting device according to the control instruction.

The video shooting assistance device provided by herein be used to execute the technical solutions of the foregoing exemplary method embodiments. The implementation principles and technical effects are similar to the method embodiments and thus will not be described again herein.

It should be noted that the location of the video shooting assistance device provided in the present disclosure may be flexibly implemented according to needs. The video shooting assistance device may be integrated in the control terminal that is independent of the carrying mechanism and the video shooting device, may be integrated in a terminal containing the carrying mechanism, may be integrated in the terminal containing the video shooting device, may be integrated in the carrying mechanism, may be integrated in the video shooting device; alternatively, it may be a device independent of the carrying mechanism, the video shooting device and the control terminal.

Some exemplary embodiments further provide a video shooting system. The video shooting system may include the video shooting assistance device shown in FIG. 5 and a carrying mechanism for carrying a video shooting device. The video shooting device is provided on the carrying mechanism.

That is, the video shooting assistance device may be integrated into the body of a gimbal (including a handheld gimbal, an on-board gimbal, an airborne gimbal, a wearable gimbal, etc.), a slide rail, a mechanical arm, a UAV, a UV, or an unmanned ship. The video shooting system may be one of a gimbal, a slide rail, a mechanical arm, a UAV, a UV, an unmanned ship, or a suitable combination thereof.

In some exemplary embodiments, the system may also include a control terminal for control of the video shooting device and/or the carrying mechanism.

A person of ordinary skill in the art would understand that all or part of the steps to implement the above methods may be completed by hardware related to program instructions. The aforementioned program may be stored in a computer-readable storage medium. When the program is executed, the steps of the above methods are executed. The aforementioned storage media may include: ROM, RAM, magnetic disks, optical disks and other media that may store program codes.

Finally, it should be noted that: the above exemplary embodiments are only to illustrate the technical solutions of the present disclosure, but not to limit the present disclosure. Although the present disclosure has been described in detail with reference to the foregoing exemplary embodiments, a person of ordinary skill in the art would understand that modifications may be made to the technical solutions disclosed in the above exemplary embodiments, or equivalent substitutions may be made for some or all of the technical features. These modifications or substitutions do not cause the essence of the corresponding technical solutions to depart from the scope of the technical solutions of the present disclosure.

What is claimed is:

1. A video shooting method, comprising:
determining a category of an object; and
determining, based on the category of the object, a target lens motion mode for shooting a video of the object, so as to shoot the video of the object with the target lens motion mode.

2. The method according to claim 1, wherein the determining of the category of the object includes:
determining the category of the object based on an object setting instruction input by a user.

3. The method according to claim 1, wherein the determining of the category of the object includes:
obtaining an image including the object; and
identifying the image to determine the category of the object.

4. The method according to claim 1, wherein the determining, based on the category of the object, of the target lens motion mode for shooting the video of the object includes:
automatically determining, based on the category of the object and a correspondence between the category of the object and the target lens motion mode automatically, the target lens motion mode for shooting the video of the object.

5. The method according to claim 4, wherein the automatically determining, based on the category of the object, of the target lens motion mode for shooting the video of the object includes:
determining, based on the category of the object and a correspondence between the category of the object and the target lens motion mode, the target lens motion mode for shooting the video of the object.

6. The method according to claim 5, wherein the correspondence includes at least one of a preset correspondence between the category of the object and the target lens motion mode, or a correspondence between a category of the video obtained and the target lens motion mode.

7. The method according to claim 1, wherein the determining, based on the category of the object, of the target lens motion mode for shooting the video of the object, so as to shoot the video of the object with the target lens motion mode includes:
automatically determining, based on the category of the object, of the target lens motion mode for shooting the video of the object, so as to automatically shoot the video of the object with the target lens motion mode

8. The method according to claim 1, further comprising:
generating a control instruction based on a lens motion parameter of the target lens motion mode;
adjusting at least one of a shooting direction or a shooting position of a video shooting device by automatically controlling a carrying mechanism for carrying the video shooting device according to the control instruction; and
controlling the video shooting device to shoot the video of the object during the adjusting.

9. The method according to claim 8, wherein the lens motion parameter includes at least one of a lens motion direction parameter, a lens motion speed parameter, or a lens motion duration parameter.

10. The method according to claim 8, further comprising:
controlling at least one of the carrying mechanism or the video shooting device according to the control instruction.

11. The method according to claim 8, further comprising:
sending the control instruction to a control terminal configured to control at least one of the carrying mechanism or the video shooting device; and
controlling, by the control terminal, the at least one of the carrying mechanism or the video shooting device according to the control instruction.

12. The method according to claim 8, wherein the carrying mechanism includes at least one of a motion mechanism or a rotating mechanism, the motion mechanism is configured to drive the video shooting device to move, and the rotating mechanism is configured to drive the video shooting device to rotate.

13. The method according to claim 12, wherein the rotating mechanism includes a gimbal, and the gimbal is fixedly or detachably installed on the video shooting device.

14. The method according to claim 13, wherein the motion mechanism includes a slide rail or a body of a vehicle, and the video shooting device is installed on the slide rail or is installed on the body of the vehicle via the gimbal.

15. The method according to claim 1, further comprising:
sending a prompt of the target lens motion mode to a user to allow the user to shoot the video of the object with the target lens motion mode according to the prompt.

16. The method according to claim 1, further comprising:
performing, in a process of video shooting of the shooting object, shooting control according to shooting control parameters corresponding to the target lens motion mode, so as to achieve shooting control corresponding to the target lens motion mode.

17. The method according to claim 1, further comprising:
performing image processing on video frames of the video of the object with image processing parameters corresponding to the target lens motion mode, so as to achieve image processing corresponding to the target lens motion mode.

18. The method according to claim 1, further comprising:
entering an object shooting mode according to a mode setting instruction input by a user, wherein the object shooting mode is configured to determine a lens motion mode according to the category of the object.

19. A video shooting assistance device, comprising:
at least one memory storing a set of instructions for assisting video shooting; and
at least one processor in communication with the at least one memory, wherein during operation, the at least one processor executes the set of instructions to:
determine a category of an object, and
determine, based on the category of the object, a target lens motion mode for shooting a video of the object, so as to shoot the video of the object with the target lens motion mode.

20. A video shooting system, comprising:
a video shooting assistance device; and
a carrying mechanism for carrying a video shooting device, wherein
the video shooting assistance device is arranged on the carrying mechanism, and
the video shooting assistance device includes:
at least one memory storing a set of instructions for assisting video shooting, and
at least one processor in communication with the at least one memory, wherein during operation, the at least one processor executes the set of instructions to:
determine a category of an object, and
determine, based on the category of the object, a target lens motion mode for shooting a video of the object, so as to shoot the video of the object with the target lens motion mode.
